(19) United States
(12) Patent Application Publication
(10) Pub. No.: US 2025/0232692 A1
(43) Pub. Date: Jul. 17, 2025

(54) MODELING THE HYDROPHILIC SURFACE OF THE EYE IN A SURGICAL EYE MODEL

(71) Applicant: Bioniko Consulting, LLC, Sunny Isles, FL (US)

(72) Inventor: Andres BERNAL, Sunny Isles, FL (US)

(73) Assignee: Bioniko Consulting, LLC, Sunny Isles, FL (US)

(21) Appl. No.: 18/410,159

(22) Filed: Jan. 11, 2024

(51) Int. Cl. G09B 23/30; C08J 3/24; C08J 7/04; C08J 7/056

(52) U.S. Cl. CPC G09B 23/30; C08J 3/245; C08J 7/0427; C08J 7/056; C08J 2329/04; C08J 2333/14; C08J 2383/04; C08J 2401/28; C08J 2439/06; C08J 2471/02; C08J 2475/04

(57) ABSTRACT

A surgical model is formed from a hydrophilic material, or is treated to have an exterior surface that is hydrophilic. Treatment can include dipping into or coating with a hydrophobic material, or the surface can have a texture formed by physical or chemical abrasion, or by plasma spraying, where the surface becomes hydrophilic. The hydrophilic surface is formed on the cornea portion of the model in a manner which maintains transparency and flexibility, and can be extended over other areas of the eye model, such as the sclera. When the eye model is coated with a hydrophilic material, the material can be allowed to dry for storing and transport, and can be rehydrated by the addition of water when the model is to be used to simulate a surgical procedure. The hydrophilicity renders the model lubricious, so that the model exhibits lifelike friction when penetrated by a surgical instrument.

### FIELD OF THE DISCLOSURE

This disclosure relates to simulating eye surgery, and more particularly to artificially reproducing the response of the natural eye surface to the contact and introduction of fluids by coating the anterior surface of the eye model.

### BACKGROUND OF THE DISCLOSURE

Many surgical techniques require dexterous movement and control by the surgeon. This dexterity cannot be adequately developed by reading textbooks or watching instructional videos. Animal models or cadavers have been the default method for hands-on surgical training. Today, simple models of the eye and head are available for study or practice.

An eye model can include a cornea into which a surgical instrument is inserted, in order to simulate insertion of surgical tools in an actual surgical procedure, such as phacoemulsification. In addition, fluids are applied to the eye during surgery, and simulation of the surgery can include introduction of fluids to the simulated eye.

### SUMMARY OF THE DISCLOSURE

In an embodiment of the disclosure, a model for simulating surgery upon the eye comprises an anterior portion sized and dimensioned to form at least a corneal portion of the model, including a surface that is transparent and elastically deformable, and shaped like the cornea of a natural eye represented by the model, the surface including a material that has hydrophilic properties corresponding to the hydrophilic properties of the natural eye; whereby the surface becomes lubricious when water is introduced to the surface, due to the hydrophilic properties.

In variations thereof, the anterior portion includes a body formed from a hydrophilic material; the material having hydrophilic properties is a hydrogel; the hydrogel is selected from the group consisting of poly(hydroxyethyl methacrylate) (pHEMA), polyvinyl alcohol (PVA), and silicone hydrogels; and/or the hydrophilic material is a polymer selected from the group consisting of polyvinylpyrrolidone (PVP), polyethylene glycol (PEG), and hydrophilic polyurethanes; the component is formed from a material that is hydrophobic, the component being treated after being formed to render the material at the surface of the component hydrophilic; and or the anterior portion includes at least a portion of the sclera area posterior to the corneal component.

In another variation thereof, the surface of the anterior portion of the model is treated to deposit the material that has hydrophilic properties by one or more of dipping, spray coating, and plasma coating.

In a further variations, the eye model is formed by treating the surface of the anterior portion of to deposit the material that has hydrophilic properties by applying the material the anterior portion in a liquid form, and allowing the liquid to dry to form the hydrophilic surface.

In another embodiment of the disclosure, a component of a model for simulating surgery upon the eye comprises an anterior portion having a body formed of a hydrophilic material, the body having a surface portion sized and dimensioned to form at least a corneal portion of the model, including a surface that is transparent and elastically deformable, and shaped like the cornea of a natural eye represented by the model, having a surface including a material that has hydrophilic properties corresponding to the hydrophilic properties of the natural eye; whereby the surface becomes lubricious when water is introduced to the surface, due to the hydrophilic properties.

In a further embodiment of the disclosure, a method of forming an eye model comprises forming an anterior portion of an eye model, including at least a corneal component, from a material that is flexible, transparent, and hydrophobic; and treating at least an exterior portion of the anterior portion to form a hydrophilic exterior surface.

In variations thereof, the exterior portion is treated to have an exterior portion including a hydrophilic material; the hydrophilic material is a hydrogel; the hydrogel is selected from the group consisting of poly(hydroxyethyl methacrylate) (pHEMA), polyvinyl alcohol (PVA), and silicone hydrogels; the hydrogel is cross-linked; a synthetic cornea is formed from the cross-linked hydrogel; and/or the exterior is treated to have a surface including a hydrophilic polymer selected from the group consisting of polyvinylpyrrolidone (PVP), polyethylene glycol (PEG), and hydrophilic polyurethanes.

In further variations thereof, treating the anterior portion includes one or more of dipping the exterior surface of the anterior portion into a hydrophilic material, spraying the exterior surface of the anterior portion with a hydrophilic material, and plasma spraying the exterior surface of the anterior portion; whereby the treated anterior portion becomes lubricious when water is introduced to the surface, due to the hydrophilic properties.

In other variations thereof, the hydrophilic material is a hydrogel, and the method further including cross-linking the hydrogel to form a synthetic cornea; and/or the anterior portion if formed by one or more of injection molding, extrusion, and 3D printing.

### BRIEF DESCRIPTION OF THE DRAWINGS

A more complete understanding of the disclosure, and the attendant advantages and features thereof, will be more readily understood by reference to the following detailed description when considered in conjunction with the accompanying drawings, in which:

FIG. 1 depicts a perspective view of an eye model in accordance with the disclosure, showing a portion of the eye model having a hydrophilic external surface;

FIG. 2 depicts a cross section of an eye model in accordance with the disclosure, showing a portion of the eye model having a hydrophilic external surface;

FIG. 3 depicts the cross-section of FIG. 2, the portion having a hydrophilic external surface extending posteriorly over the sclera;

FIG. 4 depicts the eye model of FIG. 2, the eye model provided with a pre-formed opening or a spontaneously formed opening, the opening penetrated by a tool, the insertion and movement of the tool within the opening lubricated by the hydrophilic coating, when water has been applied to a surface of the eye;

FIG. 5 diagrammatically depicts forming the hydrophilic coating by dipping a portion of the eye model into a hydrophilic material;

FIG. 6 diagrammatically depicts forming the hydrophilic coating by spray coating a portion of the eye model with a hydrophilic material; and

FIG. 7 diagrammatically depicts forming the hydrophilic coating by plasma spraying a portion of the eye model.

### DETAILED DESCRIPTION OF THE DISCLOSURE

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Headings are provided for the convenience of the reader, and are not intended to be limiting in any way.

Materials used in the fabrication of synthetic corneas can include for example transparent silicone, various TPEs, and urethanes. Examples of eye models include those shown and described for example U.S. Pat. No. 10,360,815 or 10,636,325 to the instant inventor, which have demonstrated excellent performance in simulating actual surgeries. The inventor has found, however, that surgical eye models including the inventor's and those of others often use of hydrophobic materials, including those described above. The inventor has further found this hydrophobic nature poses significant challenges in replicating the real-world conditions of ocular surgery in a simulated environment.

Specifically, in a typical ocular surgery, the surgeon often requires a clear and uninterrupted view of the surgical field. This is traditionally achieved by continuously contacting the anterior surface of the eye, and the cornea in particular, with sterile fluids, in a process termed irrigation. In accordance with the disclosure, it is desirable to replicate this irrigation to best simulate real world conditions. However, on a hydrophobic synthetic cornea, these fluids tend to form discrete droplets (“bead up”) and create beads or patches of water instead of uniformly covering the cornea, which can obstruct, obfuscate, or distort the surgeon's view.

Moreover, these hydrophobic materials also possess a high coefficient of friction, which presents an additional challenge to the smooth insertion of surgical instruments into the synthetic eye, while likewise failing to accurately mimic the response of a real human eye to such action. This can potentially lead to a less than optimal training experience, particularly for novice surgeons.

In accordance with one aspect of the disclosure, at least the outer surface of the synthetic cornea, sclera, anterior chamber region, and/or other region of the eye model is treated or coated to form a hydrophilic surface, thereby enabling irrigation to better simulate actual surgeries, while avoiding the visual problems associated with the beading of fluids due to the use of hydrophobic materials. Coating may be achieved by dipping all or a portion of the eye model in a hydrophilic coating which adheres or attaches to the model so that at least a portion of the model has hydrophilic properties on exposed surfaces. As shown diagrammatically in FIG. 5, a portion or all of the model 100 can be dipped or submerged into a liquid or a powder in a dip chamber 210. Alternatively, the coating may be carried out by spraying a liquid or a powder using a spray coater 212, such a spray gun or other spraying apparatus, as is shown diagrammatically in FIG. 6. Alternatively, all or a portion of the eye model can be treated by forming a hydrophilic surface texture using chemical or physical abrasion. FIG. 7 depicts such a treatment, diagrammatically showing a plasma sprayer treating a portion of an eye model 100, such as a cornea portion of the model, for example.

Alternatively, all or a portion of the model can be fabricated from a hydrophilic material, and no coating is required to achieve hydrophilicity upon the surface or in a cut surface. However, notwithstanding such fabrication, a hydrophilic or other coating may nonetheless be applied to the formed components, for example to hydrate, activate, or otherwise improve hydrophilicity, or to otherwise benefit the model and procedure being simulated.

### Coating

Following are materials with which the cornea and other surfaces of the eye model can be coated in accordance with the disclosure, in order to accomplish the advantages as described herein:

Polyethylene Glycol (PEG) is a hydrophilic polyether compound, whereby the cornea or other portion can be dipped into liquid PEG, after which the coated portions can be subjected to heat or UV radiation to facilitate the bonding of PEG molecules to the corneal surface.

Polyvinylpyrrolidone (PVP) is a hydrophilic and water-soluble polymer that can be dip-coating and bonded with heat or UV as described with respect to PEG.

Hydroxypropyl Methylcellulose (HPMC) is a cellulose derivative with hydrophilic properties. It can be applied through a dip-coating process, after which the coated cornea can be air dried to allow the HPMC coating to firmly adhere to the surface.

Polyvinyl Alcohol (PVA) is a hydrophilic water soluble polymer, which can be applied to surfaces of the eye model by dip coating, for example.

Zwitterionic Coatings are hydrophilic and possess both positive and negative charges, and further exhibit advantageous anti-fouling properties. They can be applied through various methods, including dip-coating, spray-coating, and Chemical Vapor Deposition (CVD).

Hydrogel Coatings are inherently hydrophilic and can absorb a significant amount of water. These can be applied as a coating to the synthetic cornea using methods like dip-coating or spray-coating. The duration of dip coating is selected to result in a film of desired thickness formed upon the surface. An optimal thickness can be determined for each selected material in order to result in the retention upon the surface of a sufficient amount of water in order to best reproduce the natural moisture and lubricity of the surface of the eye. The coating is allowed to air dry, or if needed can be dried with the application of heat, UV, or other energy based upon the characteristics of the material selected.

The choice of treatment method and coating material can be selected based on a variety of factors, including but not limited to, the desired level of hydrophilicity, longevity of the coating, compatibility with the synthetic cornea material, and cost-effectiveness.

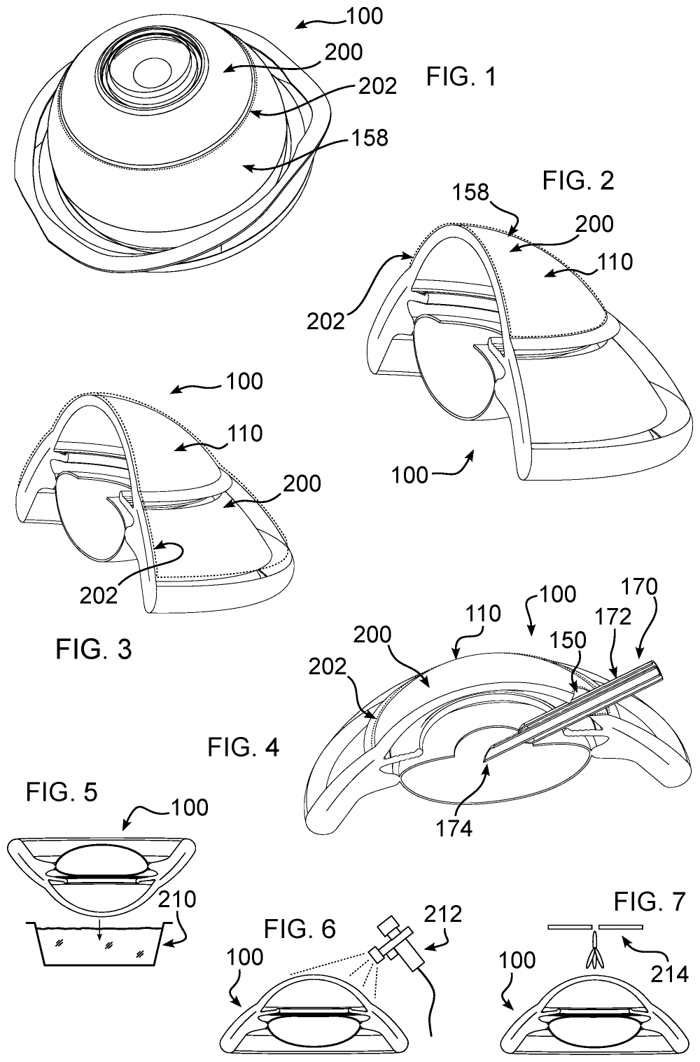

With reference to FIGS. 1, a surface treatment or coating 200 (herein ‘coating’) has been applied to an exterior surface 158 of the eye model 100. A dashed line indicates a peripheral extent 202 of coating 200. In FIGS. 1, 2 and 3, only the portion of the eye corresponding to the anterior chamber of the eye is coated, while in FIG. 3, the external surface corresponding to the anterior and posterior portions is coated. While not shown in the figures, other portions of the eye model can be covered, and in particular, portions which may be pierced by a surgical tool are advantageously coated, for reasons detailed elsewhere herein.

In an embodiment of the disclosure, an applied hydrophilic coating can be built-up to form a structure, such as the cornea or sclera, as examples. In one variation, the material is built-up using 3D printing. In one variation, the built-up coating is a hydrogel that has been cross-linked. It should be understood that other materials, including materials described herein, can be built-up in a similar fashion to form structures which are hydrophilic.

While each of the foregoing materials may readily be coated onto the surface of an artificial cornea as described, the disclosure is not intended to be limited to these methods. Particularly, the selected coating can typically be applied using any one or more of a variety of methods, including but not limited to dip coating, spray coating, brush coating, and Chemical Vapor Deposition, as well as other known and as yet unknown methods. The hydrophilic coating once formed seamlessly interacts with fluids, reducing the formation of water patches and providing a clearer view of the surgical field.

In an embodiment, a coating is formed as described herein, and is air dried or dried with the application of additional heat, UV rays, or other method appropriate to the materials used in the eye model and for the coating. As such, the eye model can be packaged, stored, and shipped without loss or disruption of the coating. Subsequently, when the eye model is ready for use, the coating can be hydrated by the addition of water or other fluid, whereby the hydrophilicity and lubricity are restored in order to benefit the procedure as described herein.

Moreover, the inventor has found that the hydrophilic treatment significantly reduces a coefficient of friction of the material, thereby facilitating a smoother insertion of surgical instruments into the synthetic eye, more closely mimicking the conditions of a real human eye. More particularly, the disclosure modifies friction, as friction is a function of lubrication, surface energy and surface roughness. Hydrophilic surfaces of the disclosure, in the presence of water, create a thin layer of water between the two sliding surfaces (e.g. a puncturing or cutting instrument, and the cornea), acting as a lubricant, thus reducing the effective coefficient of friction.

### Plasma Surface Treatment

Further in accordance with the disclosure, a surface of the eye model can be treated to become hydrophilic, particularly when previously hydrophobic. In one embodiment, the hydrophobic surface is modified by exposure to a partially ionized gas (plasma). The plasma contains various reactive species that interact with the surface of the cornea, modifying its properties. The type of gas used, treatment duration, and power levels are adjusted to achieve the desired level of hydrophilicity. Without being bound to a particular theory, plasma treatment creates a high energy discharge which can generate free radicals on the surface of the material to be treated. The presence of the free radicals increases the surface energy of the material, which overcomes cohesion forces rendering the surface more wettable. Further, in the presence of water the surface becomes more lubricious due to the retained water acting as a lubricant. Eventually, free radicals may decay, resulting in a reduction or loss of these properties; however, the time available may be adequate in some cases.

### Other Methods

In addition to or in the alternative to the coatings and plasma treatment described elsewhere herein, in accordance with the disclosure, the surface of the cornea and other surfaces of the eye model can be textured by other physical treatments, such as sanding or other abrasive, acid etching, or chemical treatment. For example, sodium hydroxide may increase surface roughness and thus wettability. However, physically increasing the roughness of the existing surface can alter or reduce the clarity of the cornea, rendering the method less desirable if clarity is excessively reduced for purposes of the particular surgery simulated.

### Fabrication of Hydrophilic Cornea

As an alternative or in addition to treatments described elsewhere herein, in accordance with the disclosure, a cornea component, or other component of the eye model is fabricated using a hydrophilic material, which also exhibits other advantageous attributes, such as being transparent and/or flexible, for example, as required by the model. In this manner, hydrophilicity and wettability are features of the material throughout, and are thus preserved as the corneal surface experience wear, increasing longevity of the model. An additional advantage is that there is no requirement to form a coating or to treat the surface to achieve hydrophilicity, thereby simplifying manufacturing, although surface coating or treatment can still be carried out if relevant to the material selected.

Materials which can be used to fabricate the eye model to thereby possess a hydrophilic surface include hydrophilic polymers such as hydrogels (e.g., poly(hydroxyethyl methacrylate) (pHEMA), polyvinyl alcohol (PVA)), polyvinylpyrrolidone (PVP), polyethylene glycol (PEG), although other materials and variants of these materials can also be used. Materials are selected for being hydrophilic, and where needed for being biocompatible, transparent, flexible, elastic, durable, and of sufficient strength for the eye structure being modelled and the physical demands of the surgery simulated. It may further be important for the material to have a suitable refractive index. The materials are also selected to be relevant and suitable for a desired manufacturing method, which can include injection molding, extrusion, 3D printing, pressing or stamping, carving, as examples. In one limited example a hydrogel could be synthesized directly in the desired cornea shape using a suitable mold and a cross-linking process.

### Additional Example

In one embodiment of the disclosure, an anterior surface of a cornea is modelled by injection molding a hydrophobic material, including for example silicone, urethane, or TPE. The resultant part is dip coated into a 2% PVA gel for 2 minutes at room temperature and is dried at room temperature.

### Lubricity

With reference to FIG. 4, it may be seen that a tool 170 is inserted through an opening 150 in the eye model. In the example shown, opening 150 is a pre-formed tool tunnel, as described for example in my U.S. patent application Ser. No. 18/231,974 filed Aug. 9, 2023. As such, coating 200 is applied within opening 150, and accordingly, opening 150 becomes lubricated for the insertion of a tool 170 once coating 200 is hydrated. Alternatively, an opening can be pre-formed or formed during the surgery that does not include coating 200 within the opening. In such case, once coating 200 is hydrated, water or other fluid is retained by coating 200 proximate the opening, and a tool 170 is lubricated as it is inserted into such opening 150. More particularly, in the case of a lubricated opening 150 or a non-lubricated opening 150, tool tip 174 first contacts water or other fluid retained by the hydrophilic coating within or proximate opening 150 and such fluid is conducted by tool tip 174 into opening 150. Similarly, tool sleeve 172 or other penetrating surgical instrument becomes coated with fluid as it passes into opening 150, and is further lubricated by fluid conducted into opening 150 by tool tip 174, and the instrument thus passes into an interior portion of the eye model with a similar friction and resistance to penetration and cutting that would experienced by a surgeon during a like procedure upon a living eye.

Accordingly, the disclosure provides a hydrophilic surface for components of an eye model, and particularly for the surface of the eye, thereby enhancing the realism of the simulated surgical experience when the eye is treated with a liquid during the surgical procedure. The disclosure further potentially contributes to better surgical outcomes by providing an improved training platform for surgeons seeking greater skill.

All references cited herein are expressly incorporated by reference in their entirety. There are many different features of the present disclosure and it is contemplated that these features may be used together or separately. Unless mention was made above to the contrary, it should be noted that all of the accompanying drawings are not to scale. Thus, the disclosure should not be limited to any particular combination of features or to a particular application of the disclosure. Further, it should be understood that variations and modifications within scope of the disclosure might occur to those skilled in the art to which the disclosure pertains. Accordingly, all expedient modifications readily attainable by one versed in the art from the disclosure set forth herein that are within the scope of the present disclosure are to be included as further embodiments of the present disclosure.

### LIST OF REFERENCE NUMERALS

100 eye model
110 cornea
150 tool tunnel
158 surface/exterior of eye
170 tool/instrument
172 tool sleeve
174 tool tip
200 surface treatment/coating
202 peripheral extent of coating
210 dip chamber
212 spray coater
214 plasma sprayer

What is claimed is:

1. A component of a model for simulating surgery upon the eye, comprising:
an anterior portion
sized and dimensioned to form at least a corneal portion of the model,
including a surface that is transparent and elastically deformable, and shaped like the cornea of a natural eye represented by the model,
the surface including a material that has hydrophilic properties corresponding to the hydrophilic properties of the natural eye;
whereby the surface becomes lubricious when water is introduced to the surface, due to the hydrophilic properties.

2. The component of claim 1, wherein the anterior portion includes a body formed from a hydrophilic material.

3. The component of claim 1, wherein the material having hydrophilic properties is a hydrogel.

4. The component of claim 3, wherein the hydrogel is selected from the group consisting of poly hydroxyethyl methacrylate) (pHEMA), polyvinyl alcohol (PVA), and silicone hydrogels.

5. The component of claim 1, wherein the hydrophilic material is a polymer selected from the group consisting of polyvinylpyrrolidone (PVP), polyethylene glycol (PEG), hydrophilic polyurethanes, and Hydroxypropyl Methylcellulose (HPMC).

6. The component of claim 1, wherein the component is formed from a material that is hydrophobic, the component being treated after being formed to render the material at the surface of the component hydrophilic.

7. The component of the claim 1, wherein the anterior portion includes at least a portion of the sclera area posterior to the corneal component.

8. A method of forming an eye model, comprising:
treating the surface of the anterior portion of claim 1 to deposit the material that has hydrophilic properties by one or more of dipping, spray coating, and plasma coating.

9. A method of forming an eye model, comprising:
treating the surface of the anterior portion of claim 1 to deposit the material that has hydrophilic properties by applying the material the anterior portion in a liquid form; and
allowing the liquid to dry to form the hydrophilic surface.

10. A component of a model for simulating surgery upon the eye, comprising:
an anterior portion having a body formed of a hydrophilic material, the body having a surface portion
sized and dimensioned to form at least a corneal portion of the model,
including a surface that is transparent and elastically deformable, and shaped like the cornea of a natural eye represented by the model,
having a surface including a material that has hydrophilic properties corresponding to the hydrophilic properties of the natural eye;
whereby the surface becomes lubricious when water is introduced to the surface, due to the hydrophilic properties.

11. A method of forming an eye model, comprising:
forming an anterior portion of an eye model, including at least a corneal component, from a material that is flexible, transparent, and hydrophobic; and
treating at least an exterior portion of the anterior portion to form a hydrophilic exterior surface.

12. The method of claim 11, wherein the exterior portion is treated to have an exterior portion including a hydrophilic material.

13. The method of claim 12, wherein the hydrophilic material is a hydrogel.

14. The method of claim 13, wherein the hydrogel is selected from the group consisting of poly(hydroxyethyl methacrylate) (pHEMA), polyvinyl alcohol (PVA), and silicone hydrogels.

15. The method of claim 13, further including cross-linking the hydrogel.

16. The method of claim 15, further including forming a synthetic cornea from the cross-linked hydrogel.

17. The method of claim 11, wherein the exterior is treated to have a surface including a hydrophilic polymer selected from the group consisting of polyvinylpyrrolidone (PVP), polyethylene glycol (PEG), and hydrophilic polyurethanes.

18. The method of claim 11, wherein treating the anterior portion includes one or more of:
dipping the exterior surface of the anterior portion into a hydrophilic material,
spraying the exterior surface of the anterior portion with a hydrophilic material, and
plasma spraying the exterior surface of the anterior portion;
whereby the treated anterior portion becomes lubricious when water is introduced to the surface, due to the hydrophilic properties.

19. The method of claim 18, wherein the hydrophilic material is a hydrogel, and the method further including cross-linking the hydrogel to form a synthetic cornea.

20. The method of claim 11, wherein the anterior portion if formed by one or more of injection molding, extrusion, and 3D printing.
